(19) United States
(12) Patent Application Publication
(10) Pub. No.: US 2021/0232014 A1
(43) Pub. Date: Jul. 29, 2021

(54) ELECTROCHROMIC DEVICES WITH INCREASED LIFETIME

(71) Applicants: Jianguo Mei, West Lafayette, IN (US); Kejie Zhao, West Lafayette, IN (US); Ke Chen, Lafayette, IN (US); Xiaokang Wang, West Lafayette, IN (US)

(72) Inventors: Jianguo Mei, West Lafayette, IN (US); Kejie Zhao, West Lafayette, IN (US); Ke Chen, Lafayette, IN (US); Xiaokang Wang, West Lafayette, IN (US)

(21) Appl. No.: 17/126,926

(22) Filed: Dec. 18, 2020

Related U.S. Application Data
(60) Provisional application No. 62/952,424, filed on Dec. 22, 2019.

(51) Int. Cl. G02F 1/161; G02F 1/155; G02F 1/1516

(52) U.S. Cl. CPC G02F 1/161; G02F 2001/164; G02F 1/15165; G02F 1/155

(57) ABSTRACT

An electrochromic device, including a first transparent conductor layer, an electrochromic layer, a toughened interface layer positioned between and operationally connected in electric communication with the first transparent conductor layer and the electrochromic layer, an electrolyte operationally connected to the electrochromic layer, an ion storage layer operationally connected to the solid electrolyte layer, and a second transparent conductor layer operationally connected to the ion storage layer. The electrochromic device remains substantially free of interfacial delamination between the first transparent conductive and the electrochromic layer for at least 10,000 duty cycles.

### TECHNICAL FIELD

This disclosure generally relates to electrooptic devices, and, in particular, to long-lived electrochromic devices and to methods of enhancing electrochromic device lifetime.

### BACKGROUND

This section introduces aspects that may help facilitate a better understanding of the disclosure. Accordingly, these statements are to be read in this light and are not to be understood as admissions about what is or is not prior art.

FIG. A displays a schematic representation of a transmissive type electrochromic device (ECD) containing electrochromic material, electrolyte and electrode material sandwiched between transparent conductive substrates. This is useful in understanding the present disclosure.

Organic electrochromic devices (OECDs) emerge in the avenues of smart windows and displays and present major advantages such as short switching time, multicolor capabilities, ambient solution processing, and low cost. OECDs are typically composed of five stacking layers: a transparent current collector, an electrochromic layer, an electrolyte, an ion storage layer, and the second transparent/reflective counter electrode. During bleaching/charging, the applied voltage drives electron extraction from the electrochromic layer (p type) with a change of its absorption band, which bleaches the polymer film. Meanwhile, counterions intercalate into the electrode film to maintain electroneutrality. The electrostatic force and mass transport collectively cause expansion in volume of the film. The electrochemical process is reversed during electrochromic coloring/discharging. OECDs in practice often require a stable cycling for hundreds of thousands of duty cycles. With cycling, a repetitive size change of the electrochromic layer—volumetric expansion during bleaching and shrinkage during coloring and bleaching, so called as mechanical breathing, persists and eventually leads to material fatigue and structural disintegration of OECDs. The interfacial incompatibility and detachment during operation become a key factor limiting the quality and lifetime of OECDs and present an obstacle to the large-scale use of OECDs.

Material deformation associated with redox reactions in electrochemical systems has been well studied over the past couple of decades. However, quantification of such chemomechanical process in-situ in polymer thin films remains a grand challenge, because of the softness of the organic polymers, the complexity of the chemical composition, the challenge of measurement down to the submicron scale, and the difficulty of monitoring the multi-layer device in a real-time operation. The reported values of volumetric strain of polypyrrole upon redox reactions have been found in the range of a few percent to a few hundreds of percent. This huge variation comes partially from the inaccuracy of the probing technique. For instance, using the servo-controller, tensile force inevitably builds up in thin films against gravity, which compromises the measurement of the actual deformation. On the other end, the electrochemistry strain microscopy is sensitive to local environmental noise and might overlook the macroscopic deformation. There is a need of an accurate yet facile method to detect the chemomechanical strain in redox active polymers in-situ and in operando.

The change of the material state in the redox reactions often induces a mechanical breathing strain and a dynamic change of the mechanical properties of the polymers, although there is little consensus in existing studies on how the mechanical behavior quantitatively evolves over electrochromic processes. Previous measurements of the mechanical properties of poly(3,4-ethylenedioxythiophene) (PEDOT) using acoustic impedance showed that the shear modulus was sensitive to the doping level, temperature, electrolyte, crosslinker, and even film thickness. It was concluded in literature that anion insertion stiffened the PEDOT film while cation expulsion caused softening. This contradicts the recent finding by some researchers via electrochemical quartz crystal microbalance with dissipation (EQCM-D) that the poly(2,2,6,6-tetramethylpiperidinyloxy-4-yl) film softens with an increase in mass while the material is in 0.5 M LiCF₃SO₃. It is worth noting that both the acoustic impedance and the EQCM-D measurement are based on presumed knowledge of the compositional fraction or the stress-strain constitutive relationship of the material. A direct method without assuming the material behavior will be advantageous to measure the mechanical properties of redox active polymers.

In the multi-layer structure of OECDs, the breathing strain in the polymeric thin film is bounded by the underneath inactive substrate, typically the current collector indium tin oxide (ITO). This mismatch induces mechanical stresses in both the film electrode and the substrate. Some researchers employed multibeam optical stress sensor and showed that the stress in the polypyrrole-electrode double layer accumulated to be over 15 MPa after 50 redox cycles. The growth of the bulk stress in the organic film as well as the interfacial stress between the soft polymer and the hard substrate can cause bending of the thin double layer, wrinkling of the film electrode, crack at the interface, and debonding of the thin film from its electron conduction network. Although tremendous efforts have been placed in synthesizing new materials and modifying the interfacial adhesion, the mechanistic understanding of the damage initiation and evolution in organic thin film electrochromics remains elusive. The rational design of OECDs of enhanced mechanical reliability requires careful analysis as to the generation of mechanical strain, the growth of stresses, the translation of mechanical failure into the degradation of device performance, and then a guidance of design to identify key parameters to optimize in future experiments.

Thus, there is an unmet need for organic electrochromic devices with increased lifetime and techniques to minimize or eliminate interfacial incompatibility and detachment during their operation. The present invention addresses this need.

### BRIEF DESCRIPTION OF DRAWINGS

Some of the figures shown herein may include dimensions. Further, some of the figures shown herein may have been created from scaled drawings or from photographs that are scalable. It is understood that such dimensions or the relative scaling within a figure are by way of example, and not to be construed as limiting. Further, in this disclosure, the figures shown for illustrative purposes are not to scale and those skilled in the art can readily recognize the relative dimensions of the different segments of the figures depending on how the principles of the disclosure are used in practical applications.

FIG. A is a schematic illustration of an electrochromic device according to the prior art.

FIG. 1A is a sketch of interfacial delamination in thin film electrochromic devices. The mechanical delamination from the current collector limits electron and counterion transport and impedes chromic switch of the film upon electrochemical cycles. FIG. 1B graphically illustrates mechanical breathing of PProDOT film and its morphology after every 60 cycles. The thin film experiences repetitive expansion and shrinkage in volume in the redox reactions which ultimately leads to the failure of the device at the interface.

FIG. 2A represents In-situ thickness measurement as a sketch of the thin film thickness measurement by the environmental nanoindentation method. d_{film} (d_{ITO}) denotes the travel displacement of the tip when the contact between the tip and the film (ITO) is detected. FIG. 2B graphically illustrates the thickness of PProDOT in the pristine and oxidized states. The upper panel shows tip displacement measured by targeted indentation. The lower panel shows the tip displacement in the x-direction measured by the scratch test. For both methods, the step height denotes the thickness of the film. FIG. 2C graphically illustrates volumetric strain ε_{V} in the range of 20˜30% is determined for PProDOT upon oxidation using the scratch and targeted indentation methods.

FIG. 3A shows Mechanical properties of PProDOT film, graphically illustrating load-displacement curves of indentation on the pristine and oxidized PProDOT films and modulus and hardness of the pristine and oxidized PProDOT as a function of the indentation depth. FIG. 3B schematically illustrates modulus and hardness of PProDOT in the pristine and dry state, the pristine in PC, the oxidized state in electrolyte after the 1^{st} cycle, the reduced state in electrolyte after 100 cycles, and the oxidized state in electrolyte after 100 cycles.

FIG. 4 shows Contour plots of the shear stress τ_{xy} in PProDOT at the oxidized state, x_{xy} at the reduced state, and the normal stress σ_{y} at the reduced state after the 1^{st}, 4^{th}, and 8^{th} cycles, respectively.

FIG. 5A graphically illustrates damage analysis of PProDOT thin film upon redox reactions, the shear stress profile (left y axis) and the interfacial damage function (right y axis) along the interface after the 4^{th} oxidation reaction and the evolution of the crack length (magenta dots), c/h₀, and the size of the damaged zone (blue dots), D/h₀, as a function of the cyclic number of the redox reaction. FIG. 5B is a phase diagram of interfacial delamination in electrochromic thin film in the space of the dimensionless breathing strain and interfacial toughness. The solid spheres represent the numerical results, while the line is drawn to delineate the boundary between the intact and delaminated conditions.

FIG. 6A shows Interfacial modification of electrochromic electrode. The surface treatment and improvement of interfacial contact considerably enhance the cyclic performance of OECDs. FIGS. 6B-6E show the images of the as-prepared PProDOT film on bare ITO, PProDOT on bare ITO after 140 cycles, PProDOT on roughened ITO after 380 cycles, and PProDOT on SiO₂ NP treated ITO after 8500 cycles, respectively. The cyan dot lines indicate the electrolyte front line. FIGS. 6F-6H show the cyclic voltammetry responses of PProDOT film on bare ITO, roughened ITO, and SiO₂ NP-treated ITO, respectively.

FIG. 7A shows 3D surface morphology by AFM and roughness of the ITO surface for bare ITO. FIG. 7B shows the 3D surface morphology for a flat region in roughened ITO. FIG. 7C shows the 3D surface morphology for a scratched region in roughened ITO. FIG. 7D shows the 3D surface morphology for an SiO₂ NP-treated ITO. Sq denotes the root mean square height roughness.

FIG. 8 shows slope (P/d) of load-displacement in the nanoindentation test when the tip is approaching the surface of the thin film. The abrupt change in slope indicates the surface detection.

FIG. 9 shows AFM image of the PProDOT thin film. Average thickness is 1222.0±1.0 nm. Customized indentation at the same location gives an average thickness of 1278.5±92.9 nm.

FIG. 10 shows traction-separation constitutive law to describe the damage initiation and crack growth at the interface. The traction force linearly increases upon reaching the maximum value T_{ic} at a displacement of uᵢ₀. The traction maintains a constant value to mimic the plastic behavior at the interface, and then decreases linearly to zero at u_{if} when the energy dissipated is equal to the interfacial toughness G_{ic}. i=I (II) in case of mode-I (II) crack. The interface damage initiates at uᵢ₀ (D=0) while crack opens at u_{if} (D=1). Unloading follows the dash line with reduced stiffness.

FIG. 11A-11B illustrates the evolution of stress and damage along the interface during 1^{st} cycle. FIG. 11A illustrates the damage function (solid lines) and shear stress profile (dotted lines) at the interface when the thin film is subject to various strains in the first oxidation reaction. FIG. 11B illustrates the shear stress profile at the interface when the thin film is subject to various strains in the first oxidation reaction (solid lines) and first reduction reaction (dotted lines).

FIG. 12A-12C is a surface profile of the ITO surface via optical surface profilometer. FIG. 12A shows bare ITO. FIG. 12B shows roughened ITO. FIG. 12C shows SiNP treated ITO. Sq denotes the root mean square height of the surface.

FIGS. 13A and 13B shows scanning electron microscopy images of SiO₂ nanoparticles deposited on ITO-glass substrate. Scale bar is 2 um in FIG. 13A and 500 nm in FIG. 13B, respectively. White arrow indicates interparticle gaps. Red arrows indicate mud cracks induced by electron-wind forces during SEM imaging.

### DETAILED DESCRIPTION

For the purposes of promoting an understanding of the principles of the disclosure, reference will now be made to the embodiments illustrated in the figures and specific language will be used to describe the same. It will nevertheless be understood that no limitation of the scope of the disclosure is thereby intended, such alterations and further modifications in the principles of the disclosure, and such further applications of the principles of the disclosure as illustrated therein being contemplated as would normally occur to one skilled in the art to which the disclosure relates.

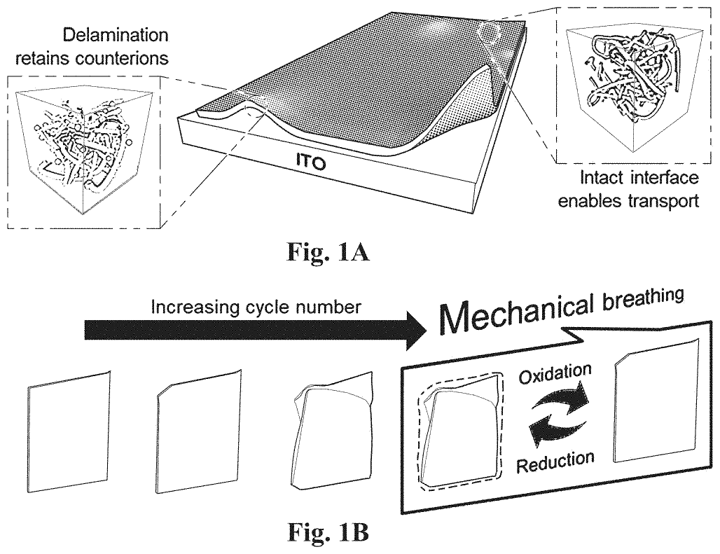

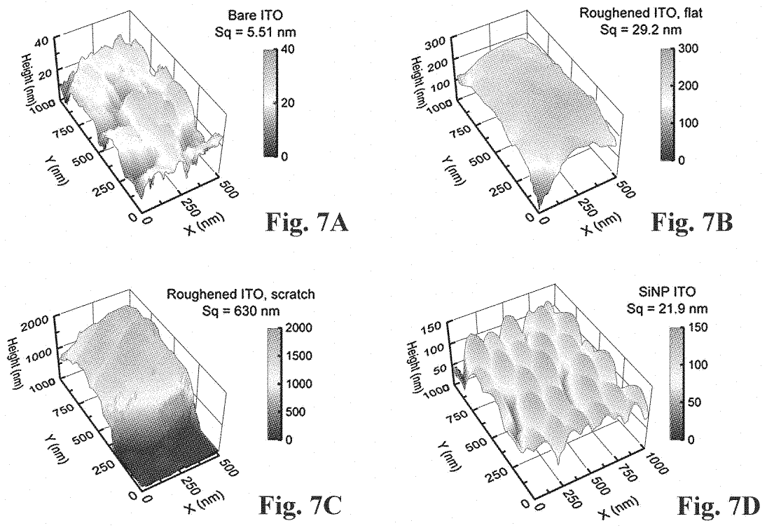

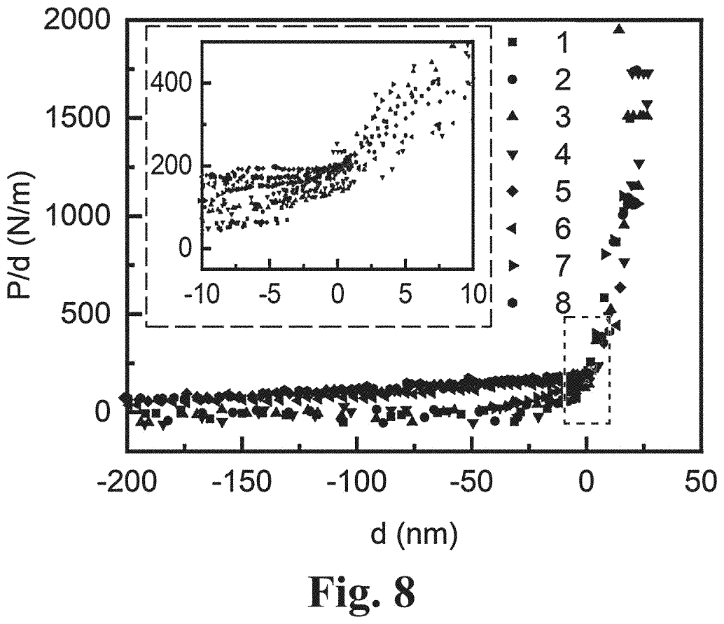

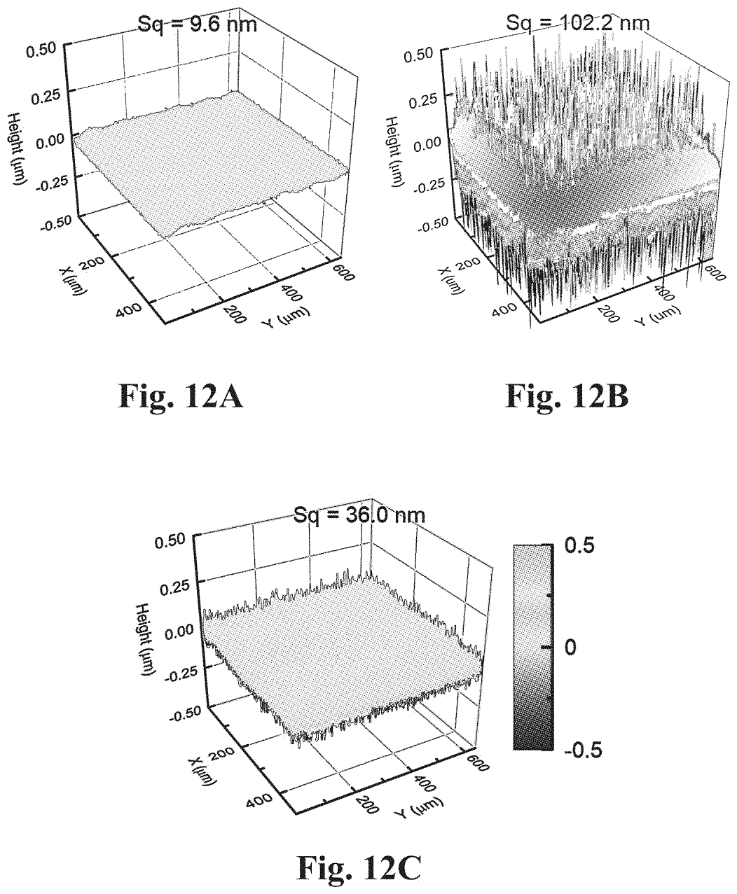

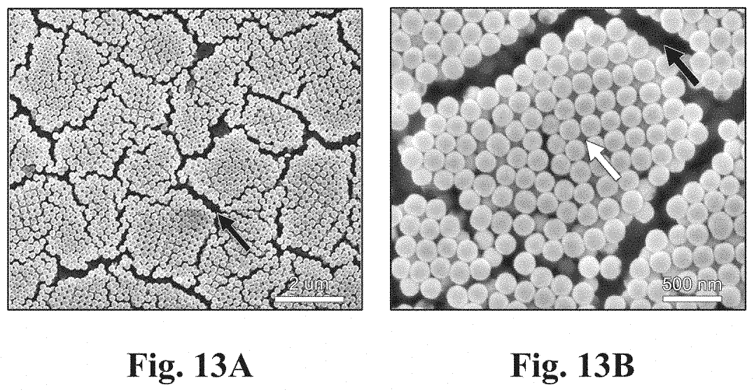

FIGS. 1-13 relate to an embodiment of the present novel technology, an improved electrochromic device enjoying increased stability and extended service life. The repetitive size change of the electrode over cycles, termed as mechanical breathing, is a factor limiting the quality and lifetime of organic electrochromic devices. The mechanical deformation originates from the electron transport and ion intercalation in the redox active material. The dynamics of the state of charge induces drastic changes of the microstructure and properties of the host, and ultimately leads to structural disintegration at the interfaces. We quantify the breathing strain and the evolution of the mechanical properties of poly(3,4-propylenedioxythiophene) thin films in-situ using customized environmental nanoindentation. Upon oxidation, the film expands nearly 30% in volume, and the elastic modulus and hardness decrease by a factor of two. The instant disclosure describes thin film delamination from an indium tin oxide (ITO) current collector under cyclic loading and details the method for toughening the interface with roughened or silica-nanoparticle coated ITO surface to significantly improve cyclic performance.

Herein, poly(3,4-propylenedioxythiophene) (PProDOT) is used as a model system to study the mechanical breathing strain upon the redox reactions and the failure at the interface of the device. The methodologies and understanding can be referenced to a large library of high-performance electrochromic materials made of PProDOT. Environmental nanoindentation technique was used in this disclosure to determine the volumetric strain of PProDOT thin films during electrochromic switching in the liquid electrolyte and then to measure the mechanical properties in the reduced and oxidized states. The thin film electrode expands up to 30% in volume upon oxidation and both elastic modulus and hardness decrease by a factor of two. Computational modeling was performed to examine the stress field and interfacial failure between an ITO current collector and the film. The stress concentration initiates the edge crack, which continuously enlarges toward the center of the film driven by the shear cracking during oxidation and a mixed mode of shearing and opening crack during reduction. The damage evolution is in excellent agreement with in-situ observations. Dimensionless quantities of the breathing strain and the crack driving force were used to generate a phase diagram to delineate ‘safe’ and ‘delamination’ zones. Regarding the design principle of an improved electrochromic electrode, the improved cyclic performance of PProDOT films of nearly two orders of magnitude of elongated cycles is demonstrated by toughening the interface with roughened or silica-nanoparticle coated ITO surface.

Several experimental details used in methods leading to this disclosure are described below.

Film Processing: The PProDOT was synthesized via direct arylation polymerization. The molecular weight was characterized by gel permeation chromatography. Then PProDOT was dissolved in chloroform and stirred overnight to form homogeneous solution with concentration of 40 mg mL⁻¹. Indium-tin-oxide (ITO) coated glass slides were ultrasonically cleaned successively in chloroform and ethanol for 10 minutes. The PProDOT solution was then spin coated on ITO coated glass slides with a spin speed of 800 rpm and 600 rpm to generate films of thicknesses of ˜500 nm and ˜1000 nm, respectively.

Surface modification of ITO. For surface roughening, two modification methods were employed to increase the roughness of ITO surface. In the first method, the ITO was ground by P1200 silicon carbide sandpaper. Very gentle force was applied in two orthogonal directions in sequence to generate visible clouds on ITO surface. The ground ITO was then cleaned through the processes related above regarding film processing part. A second method of modification involves the coating of SiO₂ nanoparticles after cleaning. Monodisperse SiO₂ nanoparticles with diameter around 200 nm were synthesized by Stöber method and then were dispersed in EtOH by sonication to form homogenous solution with concentration of 0.13 g mL⁻¹. The solution was then spin coated on the pre-cleaned ITO/glass with spin speed of 1500 rpm. After being putting in the 90° C. ovens for few minutes, the EtOH volatized competently, which produced a solid SiO₂ film on the ITO/glass substrate. The control experiment is done using as-received ITO after the same cleaning procedure.

Electrochemistry reaction: To allow indentation on the thin film, half-cell configuration is used. The PProDOT film on ITO, Pt wire, and homemade Ag/AgCl wire are the working electrode, counter electrode, and reference electrode, respectively. 1M LiPF₆ in propylene carbonate were used as the electrolyte. For indentation test and scratch test on oxidized films, voltage of 1 V against the reference electrode is applied. For the durability test. A three-electrode cell was fabricated for Cycle test with 0.2 M LiTFISI in PC as electrolyte. Voltammetry experiments were performed between 1.2 V and −0.2 V with a scan rate of 40 mV/s. The charge density was calculated by the equation

$$\int \frac{j d V}{s} ,$$

charge density has units of mC cm⁻², j is current density (mA cm⁻²), s is the scan rate (V s⁻¹), and Vis the voltage (V).

Indentation and scratch test: Instrumented indentation test was implemented to probe the mechanical properties of the films. All tests are done in Ar filled glovebox to eliminate chemical degradation by moisture and oxygen. During the test, load-displacement curve was recorded, from which modulus and hardness were calculated. Accuracy of indentation in liquid environment is verified by modulus measurement in both dry and liquid environment. Thin film method is used to calculate modulus. To measure the thickness of the films, raw displacement method and scratch test were used. For both methods, the indenter tip approached the film until the surface was found. The recorded raw displacement at detected surface unveils the thickness of the film

Finite element analysis: To explore the degradation mechanism during the cyclic redox reactions, finite element analysis was implemented using. A soft, compliant thin film (thickness of 500 nm, width of 10 um) was prepared on a hard, stiff substrate, both with plane strain assumption. Elastic and perfectly plastic relation was assumed for the polymer film. The modulus, 809 MPa, was measured from the indentation test. The yield stress, 23.2 MPa, is estimated to be ⅓ of the hardness. The substrate deformed elastically with a modulus of 80 GPa. The interface debonding was captured by cohesive zone model. Maximum normal (shear) strength is set as σ_{Y} (σ_{Y}/\sqrt{6}) such that interfacial opening crack (sliding) occur upon yielding of the film. Interfacial fracture toughness is estimated to be 1 J m⁻² for both mode I and mode II crack. As analogous to thermal expansion, isotropic strain of 10% is applied to the film upon oxidation and decreased to 0 during reduction. The mesh size was tested and converged.

Mechanical behavior of PProDOT upon electrochromic reactions: FIG. 1 shows a sketch of interfacial delamination in organic thin film electrochromic devices and its impact on the cyclic performance. The mechanical debonding of the film electrode from the current collector limited electron and counterion transport and impeded electrochromic switch of the film upon cycles. In the oxidized state, the delaminated regimes retain positive charges and counterions and therefore remain in their bleaching state in the following reduction reaction, while the intact regimes maintain electron and counterion transport and enable chromic switching. Mechanical breathing and interfacial delamination of a PProDOT film after around 160 cycles was seen by by in-situ optical observation. The repetitive deformation and the partial debonding of the film are visible by bare eyes. The optical microscope is located within a glovebox filled with Argon. The inert environment avoids contamination of moisture and oxygen to the liquid electrolyte. FIG. 1B shows a few snapshots of the film morphology after every 60 cycles starting from its pristine state. The repetitive change in size of the PProDOT electrode upon redox reactions eventually lead to the failure of the electrode at the interface.

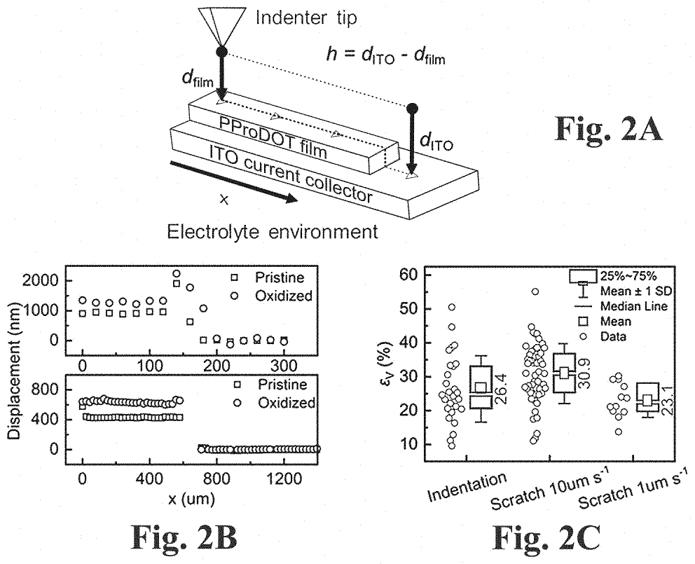

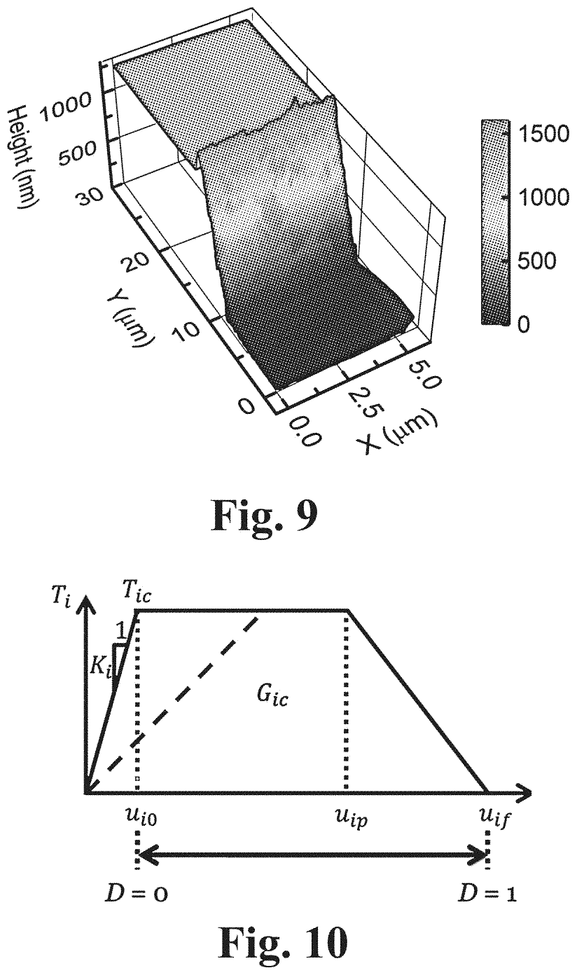

A customized nanoindentation techniques was used to measure the breathing strain in PProDOT film on ITO via targeted indentation and scratch test. FIG. 2A shows the schematic of the methodology, where d_{film} denotes the travel displacement of the tip when the contact between the tip and the film is detected, and d_{ITO} represents the tip displacement down to the ITO substrate. To eliminate the effect of the liquid flow, all the electrodes are firmly attached to a home-made fluid cell. The abrupt change in the contact stiffness when the tip approaches to the surface indicates the surface contact. For the targeted indentation, a series of indentation points across the boundary between the film and the substrate was sampled. Possible effect of sample tilting was leveraged. The tip displacement d_{film} or d_{ITO} for each targeted indentation was recorded and is shown in FIG. 2B. The step-height represents the thickness of the film. This method eliminates penetration of the tip into the sample, as is occasionally observed in the scratch test. For this non-standard method, atomic force microscope (AFM) was used to validate the targeted nanoindentation for the dry sample. The AFM images in FIG. 9 were taken at the same locations where indentation tests are performed. The thicknesses measured by the two methods are listed in Table 1. The good agreement supports the reliability of the targeted indentation measurement. Another independent measurement was done by scratch test. The tip profiles the surface with a tiny load (1˜3 uN) along a straight line crossing the boundary between the film and substrate. The tip displacement versus the scratch distance is shown in the lower panel of FIG. 2B. Again, the step height gives the thickness of the film. Note that, the film pile-up near the boundary between the film and the substrate may bring in artifacts in the measurement and the tip may end up crashing on the film from the side. The local surface detection in this case is not accurate. Here we only use the data marked in the cyan box in the case of targeted indentation, away from the boundary, to interpret the film thickness.

TABLE 1
The thin film thickness measurements by AFM and nanoindentation.

| Site No. | AFM (nm) | Nanoindenter (nm) |
|---|---|---|
| 1 | 925.3 ± 3.8 | 991.8 ± 67.6 |
| 2 | 1222.0 ± 1.0 | 1278.5 ± 92.9 |
| 3 | 1198.8 ± 2.3 | 1140.8 ± 183.4 |
| 4 | 1121.1 ± 1.6 | 1005.4 ± 94.6 |

With the two methods described above, we measure the change of thicknesses of the film at the same locations in the pristine and oxidized state in the first cycle. The nanoindentation sites are chosen ˜50 um away from the edge to avoid possible interference of film delamination from the substrate. As seen in FIG. 2b, the film surface is clearly elevated upon oxidation indicating an increase of the film thickness. For each measured location, the thicknesses of the film before and after oxidation, (h₀, h) was compared. Since the in-plane deformation of the film was bounded by the hard substrate, the volumetric strain is calculated by ε_{V}=(h−h₀)/h₀. Section c of FIG. 2 shows the results of the measured volumetric strain with the average and standard deviation, the median, and the 25%-75% range of the data. The volumetric strain was found to be 26.4% by targeted indentation, 30.9% and 23.1% by scratch test for the tip profiling velocity of 10 um s⁻¹ and 1 um s⁻¹, respectively. This overall volumetric stain gives a roughly 10% linear strain for a homogeneous and isotropic material. The deformation is recoverable if the strain is within the elastic limit and if the induced stress does not exceed the material yield strength. From a microscopic perspective, the polymer chains are entangled in nature. A tensile stress elongates the bulk polymeric material by stretching the serpentine chains to a straight configuration followed by interchain slip. The intrachain elongation is often recoverable upon removal of the external load, while the intrachain slip manifests as the permanent deformation. For the PProDOT film studied here, the averaged molecular weight Mₙ=9900 suggests that the molecular chain is made of ˜30 monomers, which corresponds to an end-to-end length of less than 10 nm. It is most likely that the interchain slip accommodates the large volumetric change of the film in the redox reaction rather than the intrachain elongation. This fact indicates that the plastic flow is invoked upon oxidation when the counterions and solvent molecules insert into the film. In the course of reduction, the counterions and solvent molecules are expelled from the host and the polymer coils aggregate by the interchain interactions.

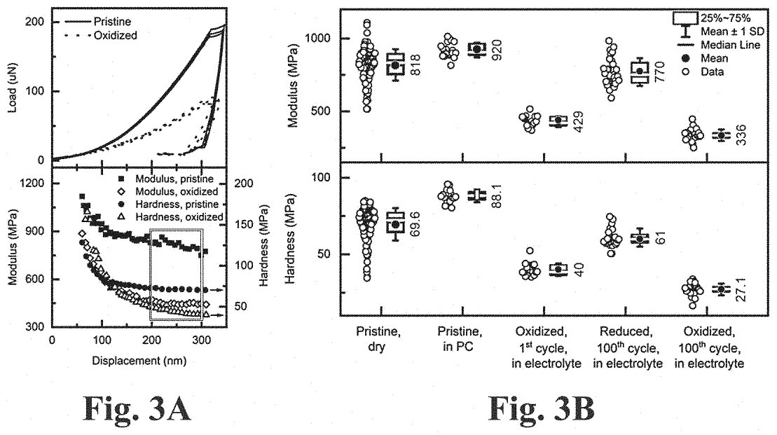

Nanoindentation was performed to measure the elastic modulus and hardness of the PProDOT film in the pristine state (dry and in PC), reduced state (in electrolyte), and oxidized state (in electrolyte) using the continuous stiffness measurement (CSM). The load-displacement response is shown in FIG. 3A. A harmonic oscillation of 2 nm at 45 Hz is superposed during loading, such that the modulus and hardness can be determined as a continuous function of the indentation depth. We have eliminated the substrate effect using the prior-established model. FIG. 3A shows that the modulus and hardness decrease as indentation depth increases. This behavior is typical for a soft film on a hard substrate and is consistent with several prior studies. Here we use the data in the plateau region marked in the cyan box to determine the average value. We measure the material properties of the pristine sample in both dry and wet states (in propylene carbonate for 2 hours) to eliminate the potential effect of the liquid environment. The results of the pristine sample are consistent but the measurement in the liquid environment seems less spread, as shown in FIG. 3B. The same procedure is employed to determine the elastic modulus and hardness of the film after oxidation. It is striking that both the modulus and hardness decrease by nearly a factor of two when the film is oxidized and the electrochemical conditioning process has limited effect on the mechanical properties. This drastic decrease in the mechanical properties might be counterintuitive. The mechanical response is related to the change of the state of charge and the microstructural feature of the polymer chains. Upon oxidation, the neutral chains lose electrons and morph into a quinoid structure. A stiffer backbone is then expected due to the nature of quinoid structure upon charge delocalization. The experimental results indicate that (1) the intermolecular interaction is mostly responsible for the mechanical response of the film, and (2) the intercalation of counterions and solvent molecules weakens the intermolecular interactions among the loosely entangled polymer chains.

Mechanistic understanding of electrochromic film delamination: With the experimental input of the breathing strain and the mechanical properties of PProDOT, finite element analysis (FEA) was conducted to understand the stress field and the crack initiation and growth in the organic thin film electrochromic devices. An elastic-perfectly plastic constitutive relationship was used to describe the PProDOT film. The elastic modulus is taken from the experimental results and the material yield strength is assumed to be one third of the hardness. To mimic the volumetric expansion upon oxidation, an isotropic thermal strain up to 10% is applied to deform the film. The polymeric film expands against the constraint provided by the substrate. The interaction of the film-substrate system at the interface is described by a traction-separation law of a trapezoidal shape. When the contacting points starts to separate, the interfacial traction increases linearly with a stiffness K until it reaches the traction limit T_{ic}. Here i denotes the normal (i=I) or tangential (i=II) loading. The damage function D remains 0 within the elastic regime and starts growing when T=T_{ic}. Following the elastic load, the interfacial traction maintains a constant to mimic the plastic flow of the film. When the dissipated energy G_{ic} is equal to the interfacial toughness Γ, the traction reduces to 0 and the interface is fully separated (D=1).

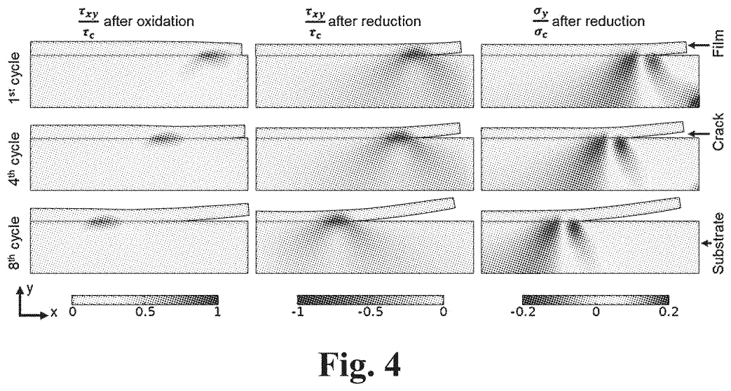

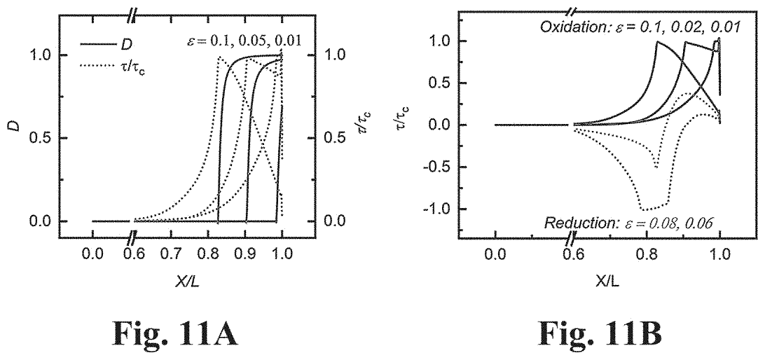

FEA results show that oxidation of the film leads to the concentration of shear stress around the free edge between the film and the substrate, as shown in the contour plot, left column of FIG. 4. Once the shear stress exceeds the interfacial strength, the interfacial damage initiates and grows, as is evident in the correlation between the damage function and the shear stress distribution in FIG. 11A. The different lines represent the various degrees of oxidation with ε=0.1 representing the complete oxidation. When the oxidation reaction proceeds, the film continues to expand with a steady growth of the interfacial crack. The normal stress associated with the oxidation reaction remains compressive, therefore the damage is driven by a pure shearing crack (mode-II). In the following reduction reaction, the PProDOT film shrinks in volume against the interfacial adhesion. The stress field within the film starts to change with an elastic unloading and succeeds by an opposite shear stress and a positive normal stress. The positive normal stress is a result of the plastic flow of the film. FIG. 11B shows the evolving shear stress at the interface in an oxidation and reduction cycle. The contour plots of the shear stress and normal stress in different cycles are shown in the middle and right columns. In the process of the reduction reaction, the interfacial damage is driven by a mixed mode of shearing and opening cracks. The positive out-of-plane normal stress is the reason to cause the bending of the film and delamination from the substrate. From the computational results we understand that the dynamics of the interfacial damage when the film electrode undergoes cyclic load: the breathing strain induces a mismatch strain in the film and the substrate; the constraint of the substrate causes concentration of stresses at the free edge; edge damage emerges as the stress exceeds the interfacial strength; the edge crack continuously grows toward the center of the film driven by shearing crack during oxidation and a mixed mode of shearing and opening crack upon reduction. The damage evolution in the finite element modeling agrees very well with the in-situ optical observation as shown in FIG. 1B.

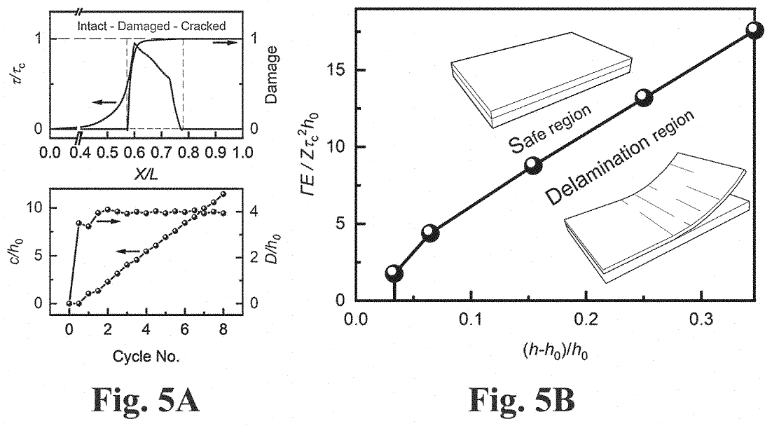

To paint the complete portrait of the interfacial damage in the electrochromic electrodes, we examine more closely the dynamics of the damage initiation, crack opening and propagation. In the early stage of cycle, the interface remains intact for the regime away from the free edge. As the redox reaction proceeds, the stress in the delaminated zones are released, and the stress concentration and mechanical damage are progressively translated toward the center of the film. The intact area, the damage zone, where the film and the substrate are partially separated, and the cracked regime are outlined in FIG. 5A. The figure also shows the shear stress profile and the interfacial damage function along the interface after the 4^{th} oxidation reaction. FIG. 5A also shows plots of the size of the damage zone and the size of the crack length, normalized by the initial film thickness, as a function of the cycle number. The crack opening is an irreversible process. We observe that the size of the damage zone reaches a nearly constant value after the initial oxidation reaction albeit the stress field alternates quite dynamically afterwards. The size of the cracked zone, on the other end, increases almost linearly staring from the first reduction reaction up to the 8th cycle. This is understood due to the combination of the reversible breathing strain in the redox reactions and the plastic deformation of the film—the collective factors result in pretty much the same magnitude of the stress field except the difference in the sign of the stresses in the oxidation and reduction processes. In addition, the shear stress generated at the interface is a dominating factor driving the film delamination. Therefore, the cracked regime increases linearly in size, separated by a nearly constant damaged zone from the intact area, over cycles.

A phase diagram was constructed to guide the design of the thin film electrochromic devices of enhanced mechanical reliability. By intuition, the mechanical damage depends on the breathing strain ε_{V}=(h−h₀)/h₀ for a thin film bounded by a substrate. Crack initiates at the interface when the driving force, the energy release rate, exceeds the interfacial toughness. The energy release rate for a thin film subject to the shear yielding is calculated as

$$G = Z \cdot \frac{{τ}_{c}}{E} \cdot {τ}_{c} \cdot {h}_{0} ,$$

where Z is a dimensionless parameter describing the geometric effect, τ_{c} is the shear yield strength, E is the elastic modulus, and h₀ is the film thickness. For the initiation of debonding of thin films, Z=1.026. The dimensionless parameter,

$$\frac{Γ E}{Z {τ}_{c}^{2} {h}_{0}} ,$$

the interfacial toughness Γ normalized by the energy release rate G, describes the competition between the crack driving force and the crack resistance. FIG. 5B shows the computational results of the critical conditions to cause film delamination in terms of the dimensionless breathing strain ε_{V}=(h−h₀)/h₀ and the material parameters

$$\frac{Γ E}{Z {τ}_{c}^{2} {h}_{0}} .$$

The solid spheres represent the numerical results, while the line is drawn to delineate the boundary between the intact and delaminated conditions. The phase diagram offers design rules to maintain the structural integrity of the thin film electrochromic devices. Interfacial damage will less likely happen by (1) minimizing the breathing strain in the redox active thin films, (2) enhancing interfacial toughness Γ, (3) utilizing materials of a higher elastic modulus E and a lower yield strength τ_{c}, and (4) reducing the film thickness h₀. In short, the general guideline is to use small-size, stiff (high modulus), and soft (low yield strength) film electrode, and tough interfacial adhesion.

Interfacial engineering for enhanced mechanical reliability: For the fabrication and device performance, the thickness of the film electrode is typically chosen to maximize the optical contrast between the two redox states. Among the rules offered by the phase diagram, the interfacial toughening by physical or chemical modification seems most practical. While providing enhanced adhesion, the modified interface is typically highly transmissive, has good electron-transport properties and remain of low cost. Current strategies include chemical bonding, physical bonding, and surface roughening to enable mechanical interlock of the film and the substrate. Here we demonstrate that by grinding the pristine ITO surface (typically via sandpaper) and by coating the silica-nanoparticles (SiO₂ NP) as a buffer layer before coating the polymeric film, the cyclic life (when current density >0.15 mA cm⁻², of the electrochromic electrode is promoted considerably as compared to bare ITO electrode (by nearly two orders of magnitudes for SiO₂ NP treated ITO).

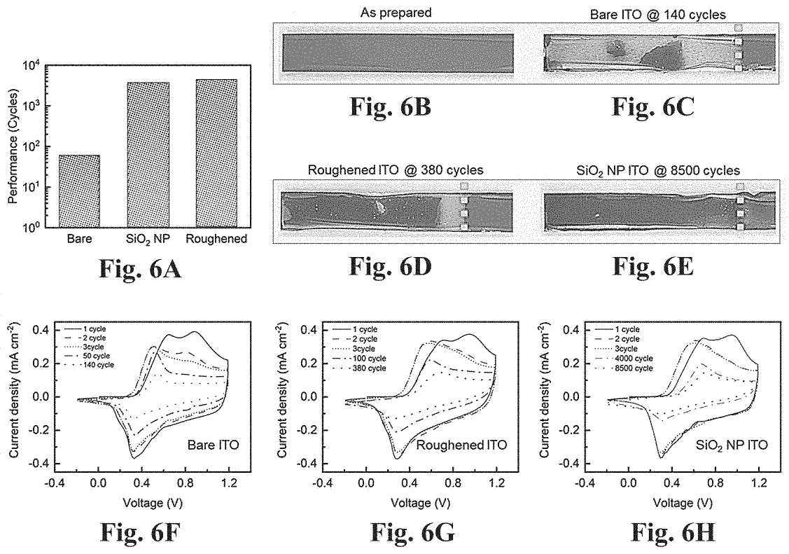

The PProDOT thin film electrodes start from the same condition (morphology and interfacial conductivity), as indicated from the pristine states of electrodes and similarity among the first-three cyclic voltammograms (CVs) cycles in both shape and current density. The CVs of PProDOT thin films on both the bare ITO and modified ITOs show a pair of redox peaks at 0.56 V and 0.29 V and same onset of the oxidation potential of ˜0.4 V, which indicates that the surface modifications have negligible effects on the electrochemical characteristics of PProDOT thin films. The current density for all three electrodes gradually drops in subsequent cycles, possibly due to microlevel delamination and ion trapping till obvious film delamination are observed. PProDOT film on bare ITO is severely damaged after 140 cycles, leaving only the magenta part in contact while the remaining region being delaminated and dysfunctional with charge density quickly dropped from 4.87 mC cm⁻² to 1.8 mC cm⁻²; parts of the PProDOT film on roughened ITO are delaminated after 380 cycles and finally reach the same electron density of 1.8 mC cm⁻² from 4.75 mC cm⁻² (FIG. 6(d)); while PProDOT film on SiO₂ NP treated ITO which started with electron density of 4.62 mC cm⁻² sustained over 8500 cycles before its current density dropped to the same level (1.8 mC cm⁻²). It is possible that only microlevel delamination happens which makes only minor edge delamination observed at the end of cycles. The interface damage is also evident by the drop in the current density.

The improved durability of the films is attributed mostly to the increased surface roughness of the ITO which enables mechanical interlock and reinforces the adhesion of the films by an increase in contact area as demonstrated by the surface morphology and roughness of bare ITO, ITO grinded by sandpaper, and SiO₂ NP coated ITO. The bare ITO has the finest surface with a root mean square height of only 5.51 nm, followed by SiO₂ NP treated ITO surface (21.9 nm). The nanoparticles (diameter of ˜200 nm) self-assemble into a well-packed hierarchy nanostructure, as shown in 3D AFM imaging. Nanoscale interparticle gaps introduces high-density mechanical interlock between the polymer film and the electrode, which significantly improves the performance. Note that the mud cracks (red arrows) are formed by the electron-wind forces at high magnification and are absent from the modified electrodes. Due to the size of the abrasion particle on sandpaper, the roughness of the grinded ITO surface varies from 29.2 nm to 620 nm. The characteristic size in grinded ITO electrode is in the micron scale, rendering a less dense mechanical interlock and less improved cyclic life of the electrode. In addition to the surface roughness, SiO₂ NP can also change the physical properties of the ITO surface which helps interfacial adhesion.

From the above description it can be seen that we employed customized environmental nanoindentation to probe the breathing strain of electrochromic thin films in-situ upon cyclic redox reactions. The PProDOT film deforms up to 30% in volume in the oxidation and reduction processes. The variation of the state of charge alters the elastic modulus and hardness by a factor of two and the film becomes softer and more compliant in the oxidized state. Theoretical modeling was employed to understand the damage initiation and propagation at the interface of electrochromic layer and the current collector. The mechanical breathing of the redox active film induces a major stress field near the free edge between the film and the substrate. Edge crack emerges when the mismatch stress exceeds the interfacial strength. The oscillatory load, resulted from the repetitive size change of the film in the redox reactions, alters the stress field, and leads to a linear progression of film delamination toward the center over cycles. The breathing strain in the electrochromic film and the dynamics of the interfacial damage are in excellent agreement with the in-situ optical observation. A phase diagram was constructed in terms of the dimensionless quantities of the breathing strain and the material parameters, to guide the design of the thin film electrochromic devices of optimum mechanical stability. The design rules were obtained by toughening the interface with roughened or silica-nanoparticle coated surface, which results in an elongated cycle lifetime of nearly two orders of magnitude compared to the untreated sample.

Based on the above detailed description, it is an objective of this disclosure to describe electrochromic device containing a first transparent conductor layer, n electrochromic layer in contact with the first transparent conductor layer, a solid electrolyte layer in contact with the electrochromic layer, an ion storage layer in contact with the solid electrolyte layer, a second transparent conductor layer in contact with the ion storage layer, wherein roughness of surface of the first transparent conductor layer in contact with the electrochromic layer is in the range of 5 nm-650 nm. In other words, surface contour features, such as peaks over valleys or acicular structures, do not have a height differential exceeding 650 nm.

It is another objective of this disclosure to describe an electrochromic device which contains a first transparent conductor layer, an electrochromic layer in contact with the first transparent conductor layer, an electrolyte in contact with the electrochromic layer, an ion storage layer in contact with the solid electrolyte layer, a second transparent conductor layer in contact with the ion storage layer, wherein interface between the first transparent conductor layer and the electrochemical layer contains inert particles, particles that do not participate in the electrochemical process during optical switching. The electrolyte of this device can be a liquid electrolyte, or solid electrolyte layer, a gel electrolyte layer, or a combination thereof. Further, the first transparent conductor of this electrochromic device can be made from any one of the following materials: indium tin oxide (ITO), doped ITO, carbon nanotubes, graphene, silver nanowires and metal mesh. The electrochromic layer of this electrochromic device can be made of an electrochromic polymer. Electrochromic polymers suitable for use an electrochromic layer of this electrochromic device include, but not limited to, PProDOT. The ion storage layer of this electrochromic device can be made from radical polymers, metal oxides and polymers. The inert particles suitable for this electrochromic device include, but not limited to, silicon dioxide, aluminum oxide, magnesium oxide, titanium oxide, zirconium oxide, and combinations thereof. The electrochromic device as described herein has no occurrence of interfacial delamination between the first transparent conductive and the electrochromic layer occurs before 10,000 electrochromic cycles of operation.

While the present disclosure has been described with reference to certain embodiments, it will be apparent to those of ordinary skill in the art that nigh-infinite other embodiments and implementations are possible that are within the scope of the present disclosure without departing from the spirit and scope of the present disclosure. For example, the solid containment materials could be formed of materials other than those noted, and could be used in high-temperature applications other than those described. The molten salts could be comprised of materials other than those noted. The non-wetted solid could be comprised of materials other than those noted. Accordingly, it should be understood that the disclosure is not limited to any embodiment described herein. It should also be understood that the phraseology and terminology employed above are for the purpose of describing the disclosed embodiments, and do not necessarily serve as limitations to the scope of the disclosure.

1. An electrochromic device comprising:
a first transparent conductor layer having a roughened surface;
an electrochromic layer in contact with the first transparent conductor layer;
a solid electrolyte layer in contact with the electrochromic layer;
an ion storage layer in contact with the solid electrolyte layer;
a second transparent conductor layer in contact with the ion storage layer, wherein the roughened surface of the first transparent conductor layer is in contact with the electrochromic layer and has a roughness of no more than 650 nm.

2. An electrochromic device comprising:
a first transparent conductor layer;
an electrochromic layer;
an interface layer positioned between and in contact with the first transparent conductor layer and the electrochromic layer;
an electrolyte in contact with the electrochromic layer;
an ion storage layer in contact with the solid electrolyte layer;
a second transparent conductor layer in contact with the ion storage layer,
wherein interface layer defines a plurality of particles that are electrochemically inactive under the switching voltages.

3. The electrochromic device of claim 2, where in the electrolyte is selected from the group comprising: liquid electrolyte, solid electrolyte, gel electrolyte, and combinations thereof.

4. The electrochromic device of claim 2, wherein the first transparent conductor is made of one of indium tin oxide (ITO), doped ITO, carbon nanotubes, graphene, silver nanowires and metal mesh.

5. The electrochromic device of claim 2, wherein the electrochromic layer is made of an electrochromic polymer.

6. The electrochromic device of claim 4, wherein the electrochromic polymer is PProDOT.

7. The electrochromic device of claim 2, wherein the ion storage layer is made of radical polymers, metal oxides and polymers.

8. The electrochromic device of claim 2, particles that are electrochemically inactive under the switching voltages are selected from the group comprising silicon dioxide, aluminum oxide, magnesium oxide, titanium oxide, zirconium oxide, and combinations thereof.

9. The electrochromic device of claim 2, wherein the electrochromic device remains substantially free of interfacial delamination between the first transparent conductive and the electrochromic layer for at least 10,000 duty cycles.

10. An electrochromic device, comprising:
a first transparent conductor layer;
an electrochromic layer;
a toughened interface layer positioned between and operationally connected in electric communication with the first transparent conductor layer and the electrochromic layer;
an electrolyte operationally connected to the electrochromic layer;
an ion storage layer operationally connected to the solid electrolyte layer; and
a second transparent conductor layer operationally connected to the ion storage layer,
wherein the electrochromic device remains substantially free of interfacial delamination between the first transparent conductive and the electrochromic layer for at least 10,000 duty cycles.

11. The electrochromic device of claim 10 wherein the toughened interface layer defines a plurality of inert particles.

12. The electrochromic device of claim 11 wherein the inert particles are selected from the group comprising silicon dioxide, aluminum oxide, magnesium oxide, titanium oxide, zirconium oxide, and combinations thereof.

13. The electrochromic device of claim 10 wherein the interface layer is roughened.

14. The electrochemical device of claim 13 wherein the surface roughening does not exceed 650 nm.
